(19) United States
(12) Patent Application Publication
(10) Pub. No.: US 2026/0303978 A1
(43) Pub. Date: Oct. 1, 2026

(54) IMAGE CAPTURE SYSTEM AND METHOD FOR SPATIAL OBSERVATION

(71) Applicant: Prime Planet Energy & Solutions, Inc., Tokyo (JP)

(72) Inventor: Takashi YOSHIDA, Kakogawa-shi (JP)

(21) Appl. No.: 19/574,435

(22) Filed: Mar. 23, 2026

(30) Foreign Application Priority Data
Mar. 26, 2025 (JP) 2025-052642

(51) Int. Cl. H04N 23/72; B23K 9/32; G02F 1/137; H01M 50/516; H04N 23/12; H04N 23/50; H04N 23/74; H04N 23/75

(52) U.S. Cl. CPC H04N 23/72; B23K 9/32; G02F 1/137; H01M 50/516; H04N 23/12; H04N 23/555; H04N 23/74; H04N 23/75

(57) ABSTRACT

An image capture system for spatial observation includes: a mirror disposed on one side surface of an observation target space; a background panel including a pattern and being disposed so as to face the mirror in a predetermined orientation across the observation target space; and an image capture device capturing an image of the background panel reflected in the mirror.

### CROSS REFERENCE TO RELATED APPLICATIONS

The present application claims priority from Japanese Patent Application No. 2025-052642 filed on Mar. 26, 2025, which is incorporated by reference herein in its entirety.

### BACKGROUND

The present invention relates to an image capture system and an image capturing method for spatial observation.

JP 2014-044154 A discloses a fluid visualization imaging device for observing an observation object having a high light intensity or an observation object in a field having a high light intensity, such as the observation of shielding gas when performing arc welding, using a schlieren phenomenon. This fluid visualization imaging device blocks light outside an observation optical path with a diaphragm means and performs observation through a bandpass filter that transmits light having a wavelength of observation light emitted by a light source. According to JP 2014-044154 A, it is possible to observe the observation object while minimizing influence from the light originating from the observation object.

JP 2017-181067 A discloses a gas visualization system and a gas visualization method that are able to visualize a low concentration leaked gas to obtain information effective for identifying a leakage location. The gas visualization system and the gas visualization method take images of a background panel and a measurement image, calculate a difference value between a pixel value of a pixel constituting the background panel and a pixel value of a pixel constituting the measurement image for each of the pixels, and generate a difference measurement image made by difference values of the respective pixels. According to JP 2017-181067 A, it is possible to visualize a low concentration leaked gas to obtain information effective for identifying a leakage location.

JP 2012-145430 A discloses a method that enables visualization of a density gradient of a gas flow by a simple image computation and an apparatus thereof. The density gradient visualization method and apparatus place a background panel behind a measurement region and a digital camera in front of the measurement region, and calculate a difference and density gradient for each of the pixels from two images, a reference image obtained by photographing the measurement region under a condition in which there is no density distribution and a measurement image obtained by photographing the measurement region under a condition in which a density distribution occurs. According to JP 2012-145430 A, it is possible to visualize a gas flow with a simple apparatus configuration that does not require a large-scale optical system.

### SUMMARY

The present inventor wishes to accurately observe gas flows during welding.

An image capture system for spatial observation disclosed herein includes: a mirror disposed on one side surface of an observation target space; a background panel including a pattern and being disposed so as to face the mirror in a predetermined orientation across the observation target space; and an image capture device capturing an image of the background panel reflected in the mirror.

An image capturing method for spatial observation disclosed herein includes the steps of: disposing a mirror on one side surface of an observation target space; disposing a background panel having a pattern so as to face the mirror in a predetermined orientation across the observation target space; and capturing an image of the background panel reflected in the mirror using an image capture device.

The image capture system and method proposed herein make it possible to observe gas flows flowing in the observation target space with higher accuracy.

### BRIEF DESCRIPTION OF THE DRAWINGS

FIG. 1A is a perspective view schematically illustrating an electricity storage device 10.

FIG. 1B is a perspective view schematically illustrating a disassembled state of the electricity storage device 10.

FIG. 2A is a schematic view illustrating the way of photographing a shielding gas 17 blown from a nozzle 17A during welding of electrode terminals 13 and 14 and a bus bar 15 of the electricity storage device 10.

FIG. 2B is a schematic view illustrating the way of photographing the shielding gas 17 blown from a nozzle 17B during welding of a case 11 and a sealing plate 12 of the electricity storage device 10.

FIG. 3A is a perspective view schematically illustrating an image capture system 100 for photographing gas flows in an observation target space 1 above a mirror 21 disposed on an object 99.

FIG. 3B is a side view schematically illustrating the image capture system 100 for photographing gas flows in the observation target space 1 above the mirror 21 disposed on the object 99.

FIG. 4 is a flowchart illustrating an image capturing method according to one embodiment of photographing gas flows in the observation target space 1 above the mirror 21 disposed on the object 99.

FIG. 5A is a perspective view schematically illustrating an image capture system 200 for photographing gas flows in an observation target space 2 between the mirror 21 and a mirror liquid crystal shutter 25.

FIG. 5B is a perspective view schematically illustrating the image capture system 200 for photographing gas flows in the observation target space 2 between the mirror 21 and the mirror liquid crystal shutter 25.

FIG. 5C is a plan view schematically illustrating the image capture system 200 for photographing gas flows in the observation target space 2 between the mirror 21 and the mirror liquid crystal shutter 25.

FIG. 5D is a plan view schematically illustrating the image capture system 200 for photographing gas flows in the observation target space 2 between the mirror 21 and the mirror liquid crystal shutter 25.

FIG. 6 is a flowchart illustrating an image capturing method according to one embodiment of photographing gas flows in the observation target space 2 between the mirror 21 and the mirror liquid crystal shutter 25.

FIG. 7 is a perspective view schematically illustrating an image capture system 100A for photographing gas flows in the observation target space 1 above the mirror 21 disposed on the object 99.

FIG. 8 is a flowchart illustrating an image capturing method according to another embodiment of photographing gas flows in the observation target space 1 above the mirror 21 disposed on the object 99.

FIG. 9A is a perspective view schematically illustrating an image capture system 200A for photographing gas flows in the observation target space 2 between the mirror 21 and the mirror liquid crystal shutter 25.

FIG. 9B is a perspective view schematically illustrating the image capture system 200A for photographing gas flows in the observation target space 2 between the mirror 21 and the mirror liquid crystal shutter 25.

FIG. 10 is a flowchart illustrating an image capturing method according to another embodiment of photographing gas flows in the observation target space 2 between the mirror 21 and the mirror liquid crystal shutter 25.

FIG. 11 is a perspective view schematically illustrating an image capture system 200B for photographing gas flows in the observation target space 2 between the mirror 21 and the mirror liquid crystal shutter 25.

FIG. 12 is a flowchart illustrating an image capturing method according to another embodiment of photographing gas flows in the observation target space 2 between the mirror 21 and the mirror liquid crystal shutter 25.

FIG. 13 is a perspective view schematically illustrating an image capture system 200C for photographing gas flows in the observation target space 2 between the mirror 21 and the mirror liquid crystal shutter 25.

FIG. 14 is a flowchart illustrating an image capturing method according to another embodiment of photographing gas flows in the observation target space 2 between the mirror 21 and the mirror liquid crystal shutter 25.

FIG. 15 is a schematic view illustrating a step of observing gas flows of the shielding gas 17 blown from the nozzle 17B.

### DETAILED DESCRIPTION

Hereinbelow, embodiments of the technology according to the present disclosure will be described with reference to the drawings. It should be noted, however, that the embodiments disclosed herein are, of course, not intended to limit the invention. The drawings are depicted schematically and do not necessarily accurately depict actual objects. The features and components that exhibit the same effects are designated by the same reference symbols as appropriate, and the description thereof will not be repeated as appropriate. In the drawings, reference characters X, Y, and Z represent the front-rear axis, the lateral axis, and the vertical axis, respectively. The Y-axis is orthogonal to the X-axis. The Z-axis is orthogonal to the X-axis and the Y-axis. Reference characters F, Rr, L, R, U, and D in the drawings represent front, rear, left, right, up, and down, respectively. These directional terms are, however, merely provided for purposes in illustration and are not intended to limit the arrangements and embodiments of the electricity storage device in any way. Unless specifically stated otherwise, the recitation of numerical ranges in the present description, such as “X to Y”, is meant to include any values between the upper limits and the lower limits, inclusive, that is, “greater than or equal to X to less than or equal to Y”.

In the present description, the term “electricity storage device” refers to a device that is capable of charging and discharging. The electricity storage device may include a variety of batteries generally referred to as lithium-ion batteries and lithium secondary batteries, as well as batteries such as lithium polymer batteries and nickel-metal hydride batteries. The secondary battery refers to a battery that is capable of charging and discharging repeatedly in association with transfer of charge carriers between positive and negative electrodes. The electricity storage device may use either an electrolyte solution or a solid electrolyte. For example, the secondary battery may be a secondary battery that uses what is called a liquid-type electrolyte solution, or may be what is called an all-solid-state battery that uses a solid electrolyte. The electricity storage device may also include capacitors, such as electric double layer capacitors and lithium-ion capacitors.

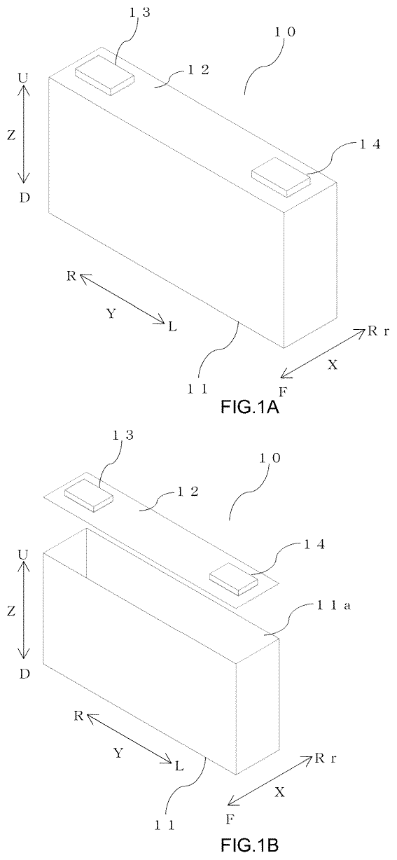

FIG. 1A is a perspective view schematically illustrating an electricity storage device 10. FIG. 1B is a perspective view schematically illustrating a disassembled state of the electricity storage device 10. As illustrated in FIG. 1A, the electricity storage device 10 includes a case 11, a sealing plate 12, and a pair of electrode terminals 13 and 14. As illustrated in FIG. 1B, the case 11 includes an opening 11a in one side surface thereof. The sealing plate 12 is a member that closes the opening 11a of the case 11. The sealing plate 12 is provided with the pair of electrode terminals 13 and 14. The pair of electrode terminals 13 and 14 are disposed at the opposite ends of the width axis Y of the sealing plate 12. Note that the method of attaching the electrode terminals 13 and 14 to the sealing plate 12 is not limited to any particular method. For example, the electrode terminals 13 and 14 may be attached to the sealing plate 12 by, for example, using a crimping process. The electrode terminals 13 and 14 may be integrally formed with the sealing plate 12. The electricity storage device 10 includes an electrode body, which is not shown in the drawings.

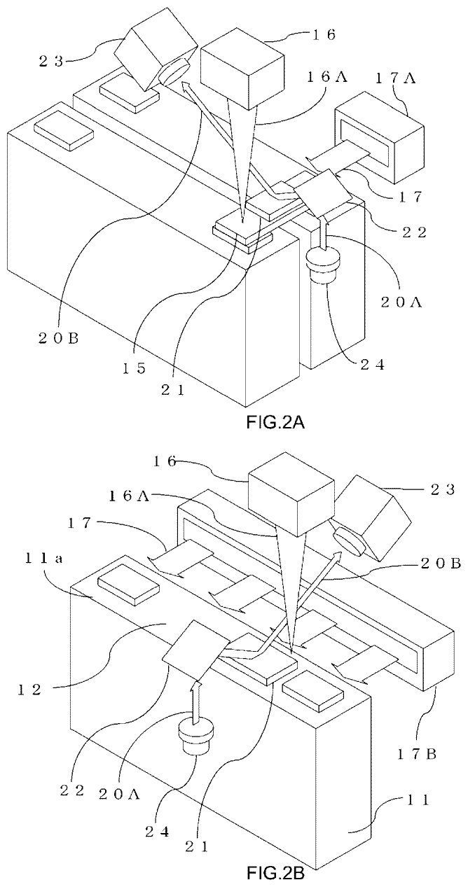

FIG. 2A is a schematic view illustrating the way of photographing a shielding gas 17 blown from a nozzle 17A during welding of electrode terminals 13 and 14 and a bus bar 15 of the electricity storage device 10. FIG. 2B is a schematic view illustrating the way of photographing the shielding gas 17 blown from a nozzle 17B during welding of a case 11 and a sealing plate 12 of the electricity storage device 10. Examples of the shielding gas 17 used herein include: inert gases, such as argon, helium, and nitrogen gas; carbon dioxide; and mixture gases thereof. When the welding location is filled with the shielding gas 17, oxygen contained in the air is prevented from acting on the welding location, reducing blow holes, pinholes, spatter, and the like. For the shielding gas 17, it may be possible to select an appropriate gas depending on the type and purpose of the metal to be welded.

Welding of the electrode terminals 13 and 14 with the bus bar 15 is described below. As illustrated in FIG. 2A, the bus bar 15 is disposed on the electrode terminals 13 and 14. Then, using a laser welding machine 16, a laser beam 16A is applied to perform welding. The electrode terminals 13, 14 and the bus bar 15 are welded together while blowing the shielding gas 17 from the nozzle 17A to the welding portion, in order to prevent melted metal from being oxidized. The direction in which the shielding gas 17 is to be blown may be any of a front-rear direction, a lateral direction, and a vertical direction. In FIG. 2A, the shielding gas 17 is blown in a front-rear direction.

Welding of the case 11 and the sealing plate 12 is described below. In welding the case 11 and the sealing plate 12, as illustrated in FIG. 2B, the sealing plate 12 is attached to the opening 11a of the case 11. Then, using the laser welding machine 16, the laser beam 16A is applied to weld the opening 11a of the case 11 and the sealing plate 12 together. At this time, the case 11 and the sealing plate 12 are welded together while blowing shielding gas 17 to the welding portion from the nozzle 17B, in order to prevent oxidization of melted metal. The direction in which the shielding gas 17 is to be blown may be any of a front-rear direction, a lateral direction, and a vertical direction. In FIG. 2B, the shielding gas 17 is blown in a front-rear direction. For example, in FIG. 2B, the laser beam 16A is applied to the peripheral edge of the sealing plate 12 attached to one side surface of the opening 11a of the battery case 11 to seal the opening 11a. At this time, the shielding gas 17 is blown from the slit-shaped nozzle 17B, formed along a longer side of the one side surface of the case 11.

The present inventor considers providing sufficient welding quality by photographing the gas flow of the shielding gas 17 blown during welding and confirming that the shielding gas 17 is blown to the intended position. However, the method of photographing the gas flow of the shielding gas 17 blown during welding and confirming that the shielding gas 17 is blown to the intended position was not established. In view of that, the present inventor conceived an image capture system and an image capturing method for spatial observation as described below.

### Image Capture System 100

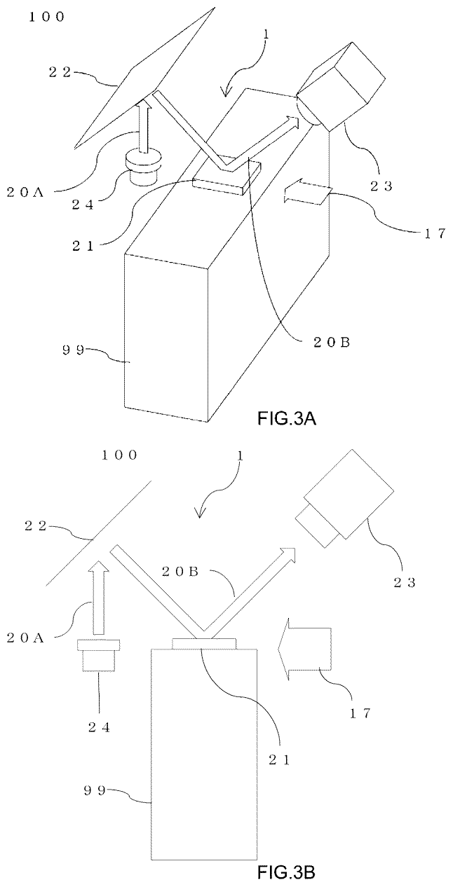

FIG. 3A is a perspective view schematically illustrating an image capture system 100. FIG. 3B is a side view schematically illustrating the image capture system 100. The image capture system 100 described herein may be used, for example, to observe the condition of the shielding gas 17 in a welding step during manufacture of an electricity storage device 10.

Herein, the image capture system 100 includes a mirror 21, a background panel 22, and an image capture device 23. The image capture system 100 may further include a light source 24. Herein, an observation target space 1 exists between the background panel 22 and the mirror 21 and also between the mirror 21 and the image capture device 23. Herein, gas flows in the observation target space 1 are photographed using a BOS (Background Oriented Schlieren) method. The BOS method visualizes a density difference in gas or liquid (or transparent material).

### Mirror 21

The mirror 21 is disposed on one side surface of the observation target space 1. In the present embodiment, the mirror 21 is disposed on an object 99. The mirror 21 reflects an image of the background panel 22 to which incident light 20A is applied by the light source 24.

### Background Panel 22

The background panel 22 includes a pattern. The background panel is disposed so that its surface provided with the pattern faces the mirror 21 in a predetermined orientation across the observation target space 1. The background panel 22 is illuminated by the incident light 20A emitted by the light source 24, so that the pattern becomes clearer. On the background panel 22, a pattern that is suitable for acquiring a schlieren image may be depicted. Examples of known patterns that are suitable for acquiring a schlieren image may include striped patterns and dot patterns.

### Image Capture Device 23

The image capture device 23 captures an image of the background panel 22 reflected in the mirror 21. The image capture device 23 is disposed at a position at which it can capture an image of the background panel 22 reflected in the mirror 21. The image capture device 23 transmits the captured image of the background panel 22 to a later-described controller 26 through communications. The communications may be performed either by wire or wirelessly.

### Light Source 24

The light source 24 applies incident light 20A toward the background panel 22. The light source 24 is configured to apply light to the background panel 22 in an orientation such that reflected light 20B reflected on the background panel 22 passes through the observation target space 1 and reflects on the mirror 21, and the reflected light 20B reflected on the mirror 21 passes through the observation target space 1 and enters the image capture device 23. In this embodiment, as illustrated in FIGS. 3A and 3B, the light source 24 is disposed below the background panel 22 to apply light upward.

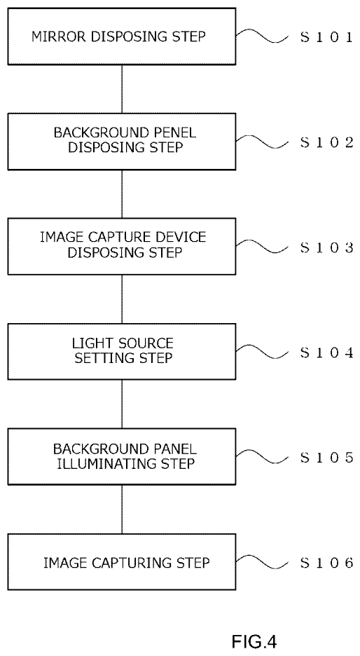

FIG. 4 is a flowchart illustrating a herein-proposed image capturing method for spatial observation. The herein-proposed image capturing method for spatial observation includes the following steps S101 to S106. The herein-proposed image capturing method for spatial observation is performed with the herein-proposed image capture system 100 for spatial observation.

Step S101 is a mirror disposing step. The mirror disposing step S101 involves disposing the mirror 21 on one side surface of the observation target space 1.

Step S102 is a background panel disposing step. The background panel disposing step S102 involves disposing the background panel disposing step S102 including a pattern. Herein, the background panel may be disposed in a predetermined orientation relative to the mirror 21 so that its surface provided with a pattern faces the mirror 21 across the observation target space 1.

Step S103 is an image capture device disposing step. The image capture device disposing step S103 involves disposing the image capture device 23. Herein, the image capture device 23 is disposed so that it can acquire an image of the background panel 22 reflected in the mirror 21.

Step S104 is a light source setting step. The light source setting step S104 involves disposing the light source 24 so that the reflected light 20B reflected on the background panel 22 passes through the observation target space 1 and reflects on the mirror 21, and the reflected light 20B reflected on the mirror 21 passes through the observation target space 1 and enters the image capture device 23.

Step S105 is a background panel illuminating step. The background panel illuminating step S105 involves applying an incident light 20A to the background panel 22.

Step S106 is an image capturing step. The image capturing step S206 involves capturing an image of the background panel 22 reflected in the mirror 21 by the image capture device 23.

Thus, with the herein-proposed image capture system and herein-proposed image capturing method for spatial observation, it is possible to obtain an image of the background panel 22 with the light that has passed through the observation target space 1 two times via the mirror 21, and to thereby obtain an image greatly affected by the wavering of the gas in the observation target space 1. For this reason, the gas flows flowing in the observation target space 1 can be observed with higher accuracy. Furthermore, in this embodiment, the light source 24 is provided so that the background panel 22 is illuminated. Such reflected light on the background panel 22 passes through the observation target space 1 two times via the mirror 21, so as to obtain an image of the background panel 22. Therefore, the image of the background panel 22 is obtained more clearly, and the wavering of the gas in the observation target space 1 can be observed more clearly.

The sequential order of the mirror disposing step S101, the background panel disposing step S102, the image capture device disposing step S103, and the light source setting step S104 may be interchanged. Furthermore, the light source setting step S104 and the background panel illuminating step S105 may be eliminated if they are unnecessary.

The herein-proposed image capture system and image capturing method for spatial observation make it possible to check the gas flows above the location to be welded. In this case, the mirror 21 may be disposed on the location to be welded. This allows the observation target space 1 to be set above the location to be welded. Then, the background panel 22, the image capture device 23, and the light source 24 may be disposed at appropriate positions in relation to the mirror 21 and the observation target space 1 disposed as described above.

Thus, an image of the background panel 22 is obtained by the light that has passed through the observation target space 1 (the space above the location to be welded herein) two times via the mirror 21. This makes it possible to obtain an image greatly affected by the wavering caused by the gas flow in the space above the location to be welded. As a result, it is easier to observe the gas flow flowing in the space above the location to be welded. For example, it becomes possible to confirm that the shielding gas 17 is blown to the intended position by photographing the gas flow of the shielding gas 17 that is blown during welding. This provides good welding quality easily. Thus, the image capture system 100 enables observation of the gas flow in the neighborhood of the surface of a member by disposing a mirror on the surface of the member even when the observation target space 1 is set near the surface of the member.

### Image Capture System 200

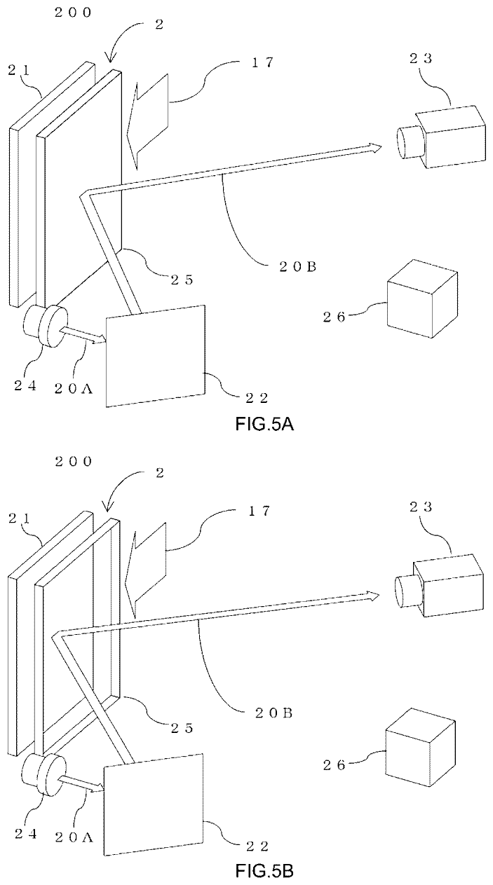

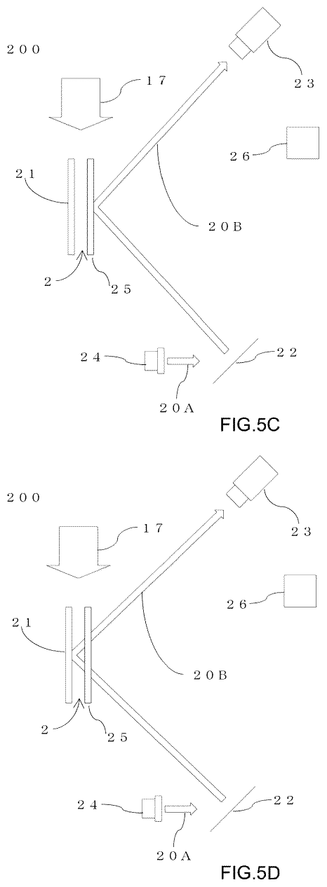

FIGS. 5A and 5C as well as FIGS. 5B and 5D are schematic views of an image capture system 200. FIGS. 5A and 5C are schematic views showing the image capture system 200 when a later-described mirror liquid crystal shutter 25 is ON. FIGS. 5B and 5D are schematic views showing the image capture system 200 when the mirror liquid crystal shutter 25 is OFF. The image capture system 200 may be used, for example, to observe the condition of the shielding gas 17 in a welding step during manufacture of an electricity storage device 10.

The image capture system 200 includes a mirror 21, a background panel 22, and an image capture device 23, a mirror liquid crystal shutter 25, and a controller 26. The image capture system 200 may further include a light source 24. Herein, an observation target space 2 exists between the mirror 21 and the mirror liquid crystal shutter 25. Herein, gas flows in the observation target space 2 are photographed using a BOS method.

### Mirror Liquid Crystal Shutter 25

The mirror liquid crystal shutter 25 is disposed between the mirror 21 and the image capture device 23 and on a side surface opposite to the mirror 21 across the observation target space 2. The mirror liquid crystal shutter 25 faces toward the mirror 21 and is disposed spaced apart from the mirror 21 with a given gap.

The mirror liquid crystal shutter 25 is able to be switched between ON and OFF by the later-described controller 26. When the mirror liquid crystal shutter 25 is ON, the mirror liquid crystal shutter 25 reflects light, as illustrated in FIGS. 5A and 5C. At this time, the image capture device 23 is able to capture an image of the background panel 22 that is reflected by the mirror liquid crystal shutter 25. When the mirror liquid crystal shutter 25 is OFF, the mirror liquid crystal shutter 25 transmits light, as illustrated in FIGS. 5B and 5D. At this time, the image capture device 23 is able to capture an image of the background panel 22 that transmits through the mirror liquid crystal shutter 25 and is reflected by the mirror 21.

### Controller 26

The controller 26 is disposed at a given location within the image capture system 200. The controller 26 is configured to be communicable with image capture device 23 and the mirror liquid crystal shutter 25. Herein, the controller 26 executes the process of switching ON and OFF of the liquid crystal shutter 25. The controller 26 receives an image of the background panel 22 that is sent by the image capture device 23. Herein, the controller 26 may be implemented by a computer that is operated according to a predetermined program. Specifically, the functions of the controller 26 may be processed by an arithmetic unit [also referred to as a processor, CPU (central processing unit), or MPU (micro-processing unit)] and a memory storage device (such as a memory and a hard disk) of each computer that constitutes the controller 26. The functions of the controller 26 may also be executed by sequence control using a microcomputer or the like.

The image capture device 23 captures a first image of the background panel 22 that is acquired when the mirror liquid crystal shutter 25 is ON. The image capture device 23 captures a second image of the background panel 22 that is acquired when the mirror liquid crystal shutter 25 is OFF. The controller 26 executes the process of acquiring an image of the gas flow flowing in the observation target space 2 between the mirror 21 and the mirror liquid crystal shutter 25 based on the first image and the second image. Herein, the first image is an image of the background panel 22 that is acquired when the mirror liquid crystal shutter 25 is ON. In the first image, light is reflected by the mirror liquid crystal shutter 25, so it is possible to obtain a schlieren image that originates from the gas flow in the space between the mirror liquid crystal shutter 25 and the image capture device 23. The second image is an image of the background panel 22 that is acquired when the mirror liquid crystal shutter 25 is OFF. In the second image, light transmits through the mirror liquid crystal shutter 25, so it is possible to obtain a schlieren image that originates from the gas flow in the space between the mirror 21 and the image capture device 23. The controller 26 executes the process of obtaining the difference between the schlieren image obtained by the first image and the schlieren image obtained by the second image. This process enables acquisition of an image of the gas flow flowing in the observation target space 2 between the mirror 21 and the mirror liquid crystal shutter 25. Herein, schlieren images may be obtained using existing software. Software for obtaining schlieren images is provided by, for example, Kato Koken Co., Ltd.

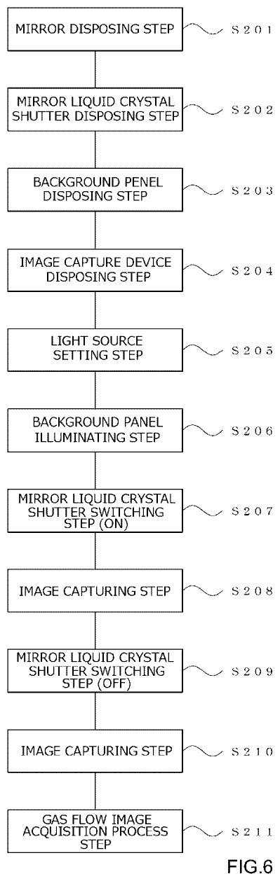

FIG. 6 is a flowchart illustrating an image capturing method according to another embodiment for spatial observation proposed herein. The herein-proposed image capturing method for spatial observation includes the following steps S201 to S211. The herein-proposed image capturing method for spatial observation is performed in the image capture system 100. The processes of steps S201 to S211 may be implemented as appropriate by control operations by a controller.

A mirror disposing step S201 is the same step as the mirror disposing step S101. A background panel disposing step S203 is the same step as the background panel disposing step S102. An image capture device disposing step S204 is the same step as the image capture device disposing step S103. A light source setting step S205 is the same step as the light source setting step S104. A background panel illuminating step S206 is the same step as the background panel illuminating step S105.

Step S202 is a mirror liquid crystal shutter disposing step. The mirror liquid crystal shutter disposing step S202 involves disposing the mirror liquid crystal shutter 25 between the mirror 21 and the image capture device 23 and on a side surface opposite to the mirror 21 across the observation target space 2. The mirror liquid crystal shutter 25 faces toward the mirror 21 and is disposed spaced apart from the mirror 21 with a given gap.

Steps S207 and S209 are each a mirror liquid crystal shutter switching step. The mirror liquid crystal shutter switching step S207 involves turning the mirror liquid crystal shutter 25 ON by the controller 26. When ON, the mirror liquid crystal shutter 25 reflects light. The mirror liquid crystal shutter switching step S209 involves turning the mirror liquid crystal shutter 25 OFF by the controller 26. When OFF, the mirror liquid crystal shutter 25 transmits light. When the mirror liquid crystal shutter 25 is OFF, light is reflected by the mirror 21. Thus, in the mirror liquid crystal shutter switching steps S207 and S209, the mirror liquid crystal shutter 25 is switched between ON and OFF appropriately.

Steps S208 and S210 are each an image capturing step. The image capturing step S208 involves capturing the first image under the condition in which the mirror liquid crystal shutter 25 is ON, using the image capture device 23. The image capturing step S210 involves capturing the second image under the condition in which the mirror liquid crystal shutter 25 is OFF, using the image capture device 23. The image capturing with the image capture device 23 may be performed in synchronous timing with switching of the mirror liquid crystal shutter 25 between ON and OFF by the controller 26.

Step S211 is a gas flow image acquisition process step. The gas flow image acquisition process step S211 involves acquiring an image of the gas flow flowing in the observation target space 2 by the controller 26 based on the first image and the second image. A process of obtaining the difference between the schlieren image obtained by the first image and the schlieren image obtained by the second image is executed. This process enables acquisition of an image of the gas flow flowing in the observation target space 2 between the mirror 21 and the mirror liquid crystal shutter 25.

Thus, the herein-proposed image capture system and image capturing method for spatial observation make it possible to acquire cross-sectional images of gas flows flowing in the observation target space 2. By moving the mirror 21 and the mirror liquid crystal shutter 25 and using the above-described image capture system, an image of the gas flow at a given position can be captured.

The sequential order of the mirror disposing step S201, the mirror liquid crystal shutter disposing step S202, the background panel disposing step S203, the image capture device disposing step S204, and the light source setting step S205 may be interchanged. Moreover, the light source setting step S205 and the background panel illuminating step S206 may be eliminated if they are unnecessary. Furthermore, it is also possible that, after completing the gas flow image acquiring process step S211, the process may return to the mirror liquid crystal shutter switching step S207, and steps S207 to S211 may be executed as many times as needed.

The herein-proposed image capture system and image capturing method for spatial observation make it possible to check the cross section of the gas flow at the location to be welded. In this case, the mirror 21 and the mirror liquid crystal shutter 25 are disposed parallel to the flow of the shielding gas 17. This allows the observation target space 2 to be set at the location to be welded. Then, the background panel 22, the image capture device 23, and the light source 24 may be disposed at appropriate positions in relation to the mirror 21 and the mirror liquid crystal shutter 25 disposed as described above.

The herein-proposed image capture system and image capturing method for spatial observation make it possible to acquire cross-sectional images of gas flows flowing in the observation target space 2 between the mirror 21 and the mirror liquid crystal shutter 25. As a result, it becomes possible to confirm that the shielding gas 17 is blown to the intended position by photographing the gas flow of the shielding gas 17 that is blown during welding. Furthermore, at this time, it is possible to obtain an image of the background panel 22 with the light that has passed through the observation target space 2 two times via the mirror 21, and to thereby obtain an image greatly affected by the wavering of the gas in the observation target space 2. For this reason, the gas flows flowing in the observation target space 2 can be observed with higher accuracy. Thus, the welding location is designated as the observation target space 2, and the gas flows flowing in such an observation target space 2 can be observed with high accuracy while changing positions sequentially. This serves to easily provide good welding quality.

### Image Capture System 100A

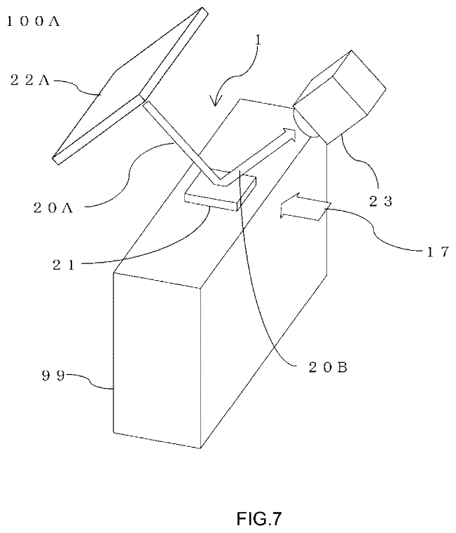

FIG. 7 is a schematic view illustrating an image capture system 100A. The image capture system 100A uses a backlighted background panel 22A in place of the background panel 22 used in the image capture system 100. The backlighted background panel 22A is an image depicted by a backlighted liquid crystal device.

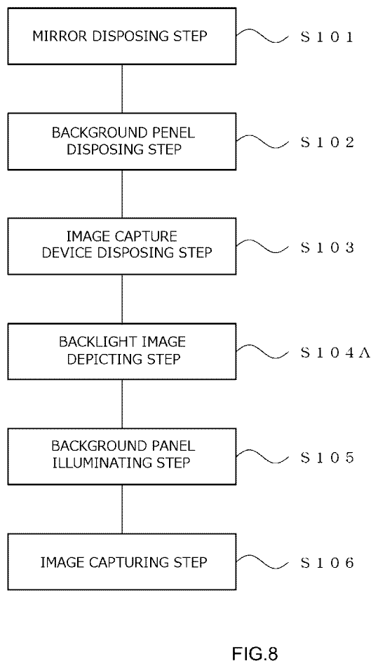

FIG. 8 is a flowchart illustrating an image capturing method according to another embodiment for spatial observation proposed herein. The herein-proposed image capturing method for spatial observation employs a backlight image depicting step S104A, in place of the light source setting step S104.

Employing the backlighted background panel 22A enables an image of the gas flows in the observation target space 1 to be captured without using the light source 24.

### Image Capture System 200A

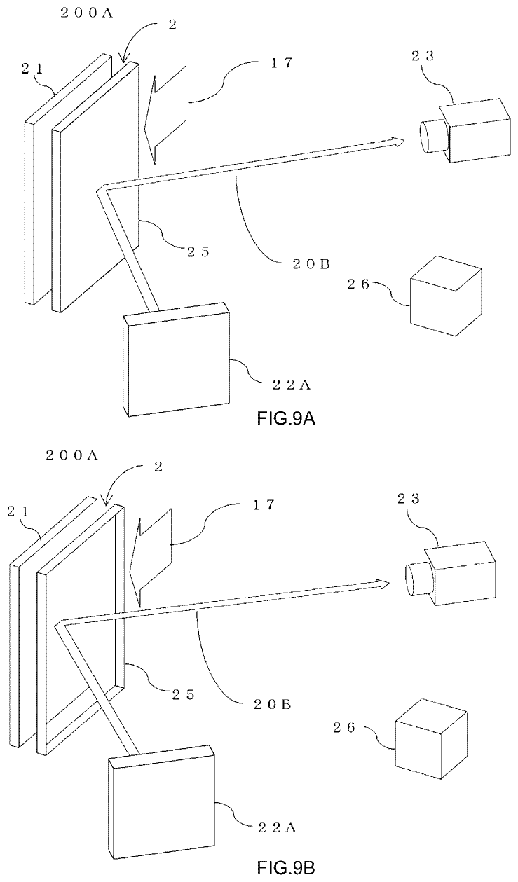

FIGS. 9A and 9B are schematic views illustrating an image capture system 200A. The image capture system 200A uses a backlighted background panel 22A in place of the background panel 22 used in the image capture system 200.

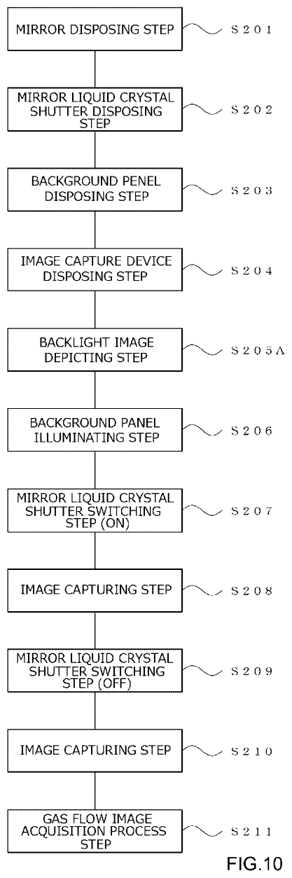

FIG. 10 is a flowchart illustrating an image capturing method according to another embodiment for spatial observation proposed herein. The herein-proposed image capturing method for spatial observation employs a backlight image depicting step S205A, in place of the light source setting step S205.

Employing the backlighted background panel 22A enables an image of the gas flows in the observation target space 2 to be captured without using the light source 24.

### Image Capture System 200B

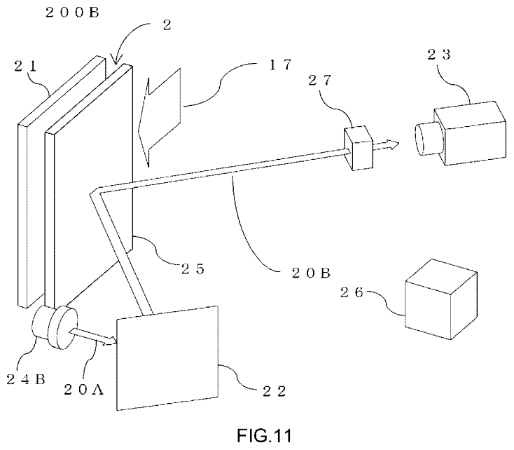

FIG. 11 is a schematic view illustrating an image capture system 200B. A light source 24B and a filter 27 are added to the image capture system 200.

### Light Source 24b

The light source 24B is configured to switch between emitting a first wavelength light with a first wavelength and emitting a second wavelength light with a different wavelength from the first wavelength.

### Filter 27

The filter 27 selectively transmits the first wavelength light and the second wavelength light. The filter 27 is configured to be able to switch between a first mode and a second mode. The filter 27 allows a reflected light 20B having a first wavelength to transmit therethrough when in the first mode. The filter 27 allows the reflected light 20B having a second wavelength to transmit therethrough when in the second mode. The filter 27 is disposed between the mirror liquid crystal shutter 25 and the image capture device 23. The filter 27 is disposed on the optical path of the reflected light 20B reflected by the mirror 21 and the mirror liquid crystal shutter 25.

### Controller 26

In addition to the above-described processes, the controller 26 executes a process of switching the wavelength of the light source 24B from one to another. The controller 26 further executes a process of switching the mode of the filter 27 from one to another. The controller 26 is configured to be communicable with the filter 27.

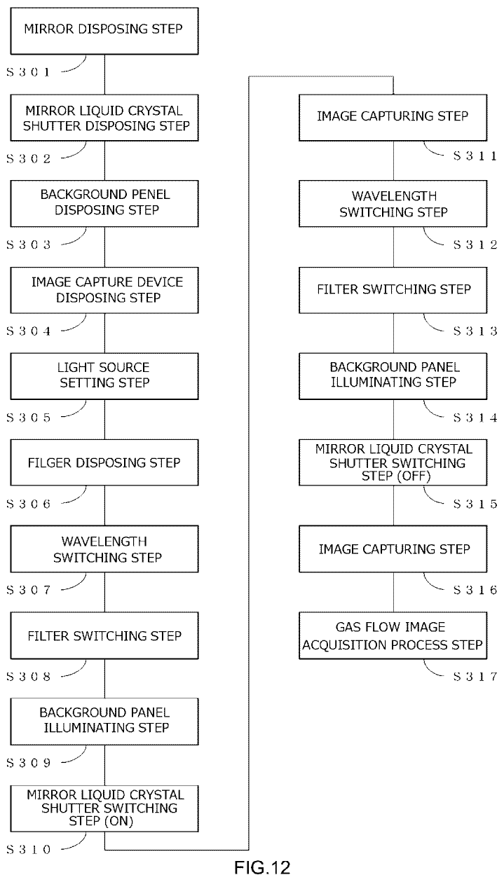

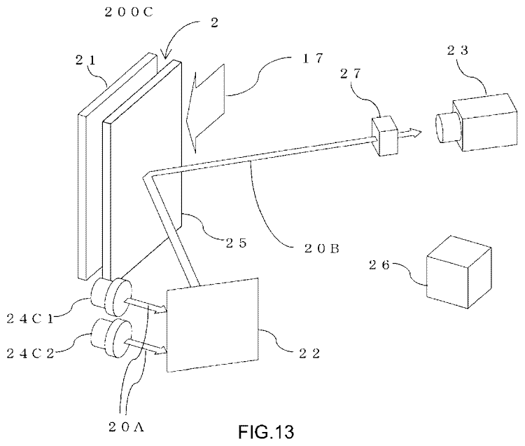

FIG. 12 is a flowchart illustrating an image capturing method according to another embodiment for spatial observation proposed herein. The image capturing method for spatial observation proposed herein further includes a filter disposing step S306, wavelength switching steps S307 and S312, and filter switching steps S308 and S313 additionally to the image capturing method of the image capture system 200.

Step S306 is a filter disposing step. The filter disposing step S306 involves disposing the filter 27 on the optical path of the reflected light 20B reflected by the mirror 21.

Steps S307 and S312 are each a wavelength switching step. The wavelength switching step S307 involves, for example, switching the light source 24B so as to emit a first wavelength light. The wavelength switching step S312 involves, for example, switching the light source 24B so as to emit a second wavelength light. The wavelength of the light source 24B is switched by the controller 26.

Steps S308 and S313 are each a filter switching step. The filter switching step S308 causes the filter 27 to transmit through the reflected light 20B having a first wavelength. The filter switching step S313 causes the filter 27 to transmit through the reflected light 20B having a second wavelength. The mode of the filter 27 is switched by the controller 26.

Steps S309 and S314 are each a background panel illuminating step. The background panel illuminating step S309 involves applying the incident light 20A having a first wavelength to the background panel 22. The background panel illuminating step S314 involves applying the incident light 20A having a second wavelength to the background panel 22.

Steps S311 and S316 are each an image capturing step. The image capturing step S311 involves causing the image capture device 23 to capture a first image of the background panel 22 that is illuminated by the incident light 20A having a first wavelength. The image capturing step S316 involves causing the image capture device 23 to capture a second image of the background panel 22 that is illuminated by the incident light 20A having a second wavelength.

The light source 24B and the filter 27 switches light between the first wavelength light and the second wavelength light, so the image of the background panel 22 can be obtained more clearly. Note that either one of the light source 24B or the filter 27 may be omitted.

The sequential order of the wavelength switching step S307 and the filter switching step S308 may be interchanged. The sequential order of the wavelength switching step S312 and the filter switching step S313 may be interchanged. The order of light application with the first wavelength light and the second wavelength light may be interchanged. Furthermore, it is also possible that, after completing the gas flow image acquiring process step S317, the process may return to the wavelength switching step S307, and steps S307 to S317 may be executed as many times as needed.

The mirror liquid crystal shutter 25 may be either ON or OFF, and for example, it may reflect the first wavelength light and transmits the second wavelength light. In this case, the mirror 21 reflects the second wavelength light. When the first wavelength light and the second wavelength light are emitted simultaneously from the light source 24B as well, it is also possible to acquire an image of the gas flow flowing in the observation target space 2 between the mirror 21 and the mirror liquid crystal shutter 25. In this case as well, it is possible to obtain an image of the background panel 22 with the light that has passed through the observation target space 2 two times via the mirror 21, and to thereby obtain an image greatly affected by the wavering of the gas in the observation target space 2. Therefore, it is possible to acquire an image of the gas flow flowing in the observation target space 2 between the mirror 21 and the mirror liquid crystal shutter 25 more accurately.

### Image Capture System 200c

FIG. 13 is a schematic view illustrating an image capture system 200C. The image capture system 200C includes a light source 24C, in place of the light source 24B of the image capture system 200B.

### Light Source 24c

The light source 24C includes a first light source 24C1 and a second light source 24C2. The first light source 24C 1 emits light with a first wavelength. The second light source 2 4C2 emits light with a second wavelength. The light source 24C is configured to be able to switch between the first light source 24C 1 and the second light source 24C2.

### Controller 26

In addition to the above-described processes, the controller 26 executes a process of switching the light source 24C.

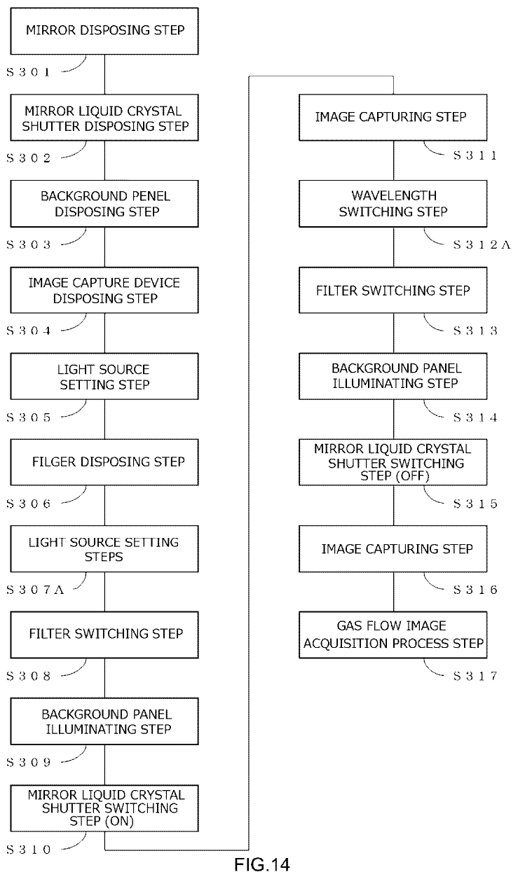

FIG. 14 is a flowchart illustrating an image capturing method according to another embodiment for spatial observation proposed herein. The herein-proposed image capturing method for spatial observation employs a light source setting step S307A, in place of the wavelength switching step S307. It also employs a light source setting step S312A, in place of the wavelength switching step S312.

Steps S307A and S312A are each a light source switching step. The light source switching step S307A involves, for example, causing the light source 24C to switch the light source to the first light source 24C1. The light source switching step S312A involves, for example, causing the light source 24C to switch the light source to the second light source 24C2. The light source 24C is switched by the controller 26.

The light source 24C is switched between the first light source 24C1 and the second light source 24C2, so the image of the background panel 22 can be obtained more clearly. Moreover, by the filter 27, the wavelength is switched between the first wavelength light and the second wavelength light, so the image of the background panel 22 can be obtained more clearly. Note that either one of the light source 24C or the filter 27 may be omitted.

The sequential order of the light source switching step S307A and the filter switching step S308 may be interchanged. The sequential order of the light source switching step S312A and the filter switching step S313 may be interchanged. The order of light application by the first light source and the second light source may be interchanged. Furthermore, it is also possible that, after completing the gas flow image acquiring process step S317, the process may return to the wavelength switching step S307A, and steps S307A to S314 may be executed as many times as needed.

The mirror liquid crystal shutter 25 may be either ON or OFF, and for example, it may reflect the first wavelength light and transmits the second wavelength light. In this case, the mirror 21 reflects the second wavelength light. When the first wavelength light and the second wavelength light are emitted simultaneously from the light source 24C as well, it is also possible to acquire an image of the gas flow flowing in the observation target space 2 between the mirror 21 and the mirror liquid crystal shutter 25.

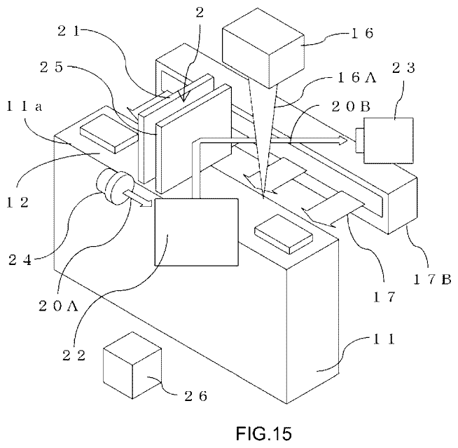

As illustrated in FIG. 2, when laser welding the peripheral edge of the sealing plate 12 attached to the opening 11a of one side surface of the battery case 11, the shielding gas 17 may be blown to the peripheral edge of the sealing plate 12 from the slit-shaped nozzle 17B, formed along a longer side of the one side surface of the case 11. FIG. 15 is a schematic view illustrating a step of observing gas flows of the shielding gas 17 blown from the nozzle 17B. As illustrated in FIG. 15, when observing the gas flows of the shielding gas 17 blown out from the slit-shaped nozzle 17B, the mirror 21 disposed in an orientation orthogonal to the longitudinal axis of the slit-shaped nozzle 17B and the mirror liquid crystal shutter 25 facing the mirror 21 with a predetermined gap are disposed so as to be able to observe the gas flows of the shielding gas 17 blown out from the slit-shaped nozzle 17B. Then, the observation target space 2 is set between the mirror 21 and the mirror liquid crystal shutter 25, and the background panel 22, the image capture device 23, and the light source 24 may be disposed at appropriate positions in relation to the mirror 21 and the mirror liquid crystal shutter 25. Then, while shifting the positions of the mirror 21 and the mirror liquid crystal shutter 25 sequentially along the longitudinal axis of the slit-shaped nozzle 17B, the gas flow blowing out from the slit-shaped nozzle 17B may be observed sequentially along the longitudinal axis. This makes it possible to observe the gas flow blown out from the slit-shaped nozzle 17B. In addition, in this case as well, it is possible to obtain an image of the background panel 22 with the light that has passed through the observation target space 2 two times via the mirror 21, and to thereby obtain an image greatly affected by the wavering of the gas in the observation target space 2. Therefore, it is possible to acquire an image of the gas flow flowing in the observation target space 2 between the mirror 21 and the mirror liquid crystal shutter 25 more accurately.

The image capture systems disclosed herein such as the image capture systems 200A to 200C make it possible to observe the gas flows sequentially by dividing the observation target space 2 even when the observation target space 2 is large as a whole. Therefore, the gas flows can be observed even when the observation target space 2 is large.

Various embodiments of the technology according to the present disclosure have been described hereinabove. Unless specifically stated otherwise, the embodiments described herein do not limit the scope of the present invention. It should be noted that various other modifications and alterations may be possible in the embodiments of the technology disclosed herein. In addition, the features, structures, or steps described herein may be omitted as appropriate, or may be combined in any suitable combinations, unless specifically stated otherwise. In addition, the present description includes the disclosure as set forth in the following items.

### Item 1

An image capture system for spatial observation, comprising:
a mirror disposed on one side surface of an observation target space;
a background panel including a pattern and being disposed so as to face the mirror in a predetermined orientation across the observation target space; and
an image capture device capturing an image of the background panel reflected in the mirror.

### Item 2

The image capture system according to item 1, further including a light source applying light to the background panel in an orientation such that reflected light reflected on the background panel passes through the observation target space and reflects on the mirror, and the reflected light reflected on the mirror passes through the observation target space and enters the image capture device.

### Item 3

The image capture system for spatial observation according to item 1 or 2, wherein the background panel includes an image depicted by a backlighted liquid crystal device.

### Item 4

The image capture system for spatial observation according to any one of items 1 through 3, further including:
a mirror liquid crystal shutter disposed between the mirror and the image capture device and on a side surface opposite to the mirror across the observation target space; and
a controller, wherein
the controller is configured to execute:
   a switching process of switching ON and OFF of the liquid crystal shutter; and
   a process of acquiring an image of a gas flow flowing in the observation target space based on a first image of the background panel that is acquired when the mirror liquid crystal shutter is ON and a second image of the background panel that is acquired when the mirror liquid crystal shutter is OFF.

### Item 5

The image capture system for spatial observation according to item 4, further including:
a filter disposed on an optical path of reflected light reflected by the mirror and the mirror liquid crystal shutter and selectively passing a first wavelength light and a second wavelength light having a different wavelength from the first wavelength, and wherein:
the light source is configured to switch between emitting the first wavelength light and emitting the second wavelength light; and
the controller is configured to further execute a process of switching the light emitted by the light source between the first wavelength light and the second wavelength light.

### Item 6

The image capture system for spatial observation according to item 4, further including:
a filter disposed on an optical path of reflected light reflected by the mirror and the mirror liquid crystal shutter and selectively passing a first wavelength light and a second wavelength light having a different wavelength from the first wavelength, and wherein:
the light source includes a first light source emitting the first wavelength light and a second light source emitting the second wavelength light; and
the controller is configured to further execute a process of switching between light emission by the first light source and light emission by the second light source.

### Item 7

The image capture system for spatial observation according to any one of items 4 through 6, wherein: the mirror liquid crystal shutter reflects the first wavelength light and transmits the second wavelength light; and the mirror reflects the second wavelength light.

### Item 8

An image capturing method for spatial observation, including:
disposing a mirror on one side surface of an observation target space;
disposing a background panel so as to face the mirror in a predetermined orientation across the observation target space;
disposing an image capture device; and
capturing an image of the background panel reflected in the mirror using the image capture device.

### Item 9

The image capturing method for spatial observation according to item 8, further including:
setting a light source so as to apply light to the background panel so that reflected light reflected on the background panel passes through the observation target space and reflects on the mirror, and the reflected light reflected on the mirror passes through the observation target space and enters the image capture device; and
causing the light source to apply light to the background panel.

### Item 10

The image capturing method for spatial observation according to item 8 or 9, wherein the background panel includes an image depicted by a backlighted liquid crystal device.

### Item 11

The image capturing method for spatial observation according to claim any one of 8 through 10, further including:
disposing a mirror liquid crystal shutter between the mirror and the image capture device and on a side surface opposite to the mirror across the observation target space; and wherein
the controller is configured to execute the processes of:
   switching ON and OFF of the liquid crystal shutter; and
   acquiring an image of a gas flow flowing in the observation target space based on a first image of the background panel that is acquired when the mirror liquid crystal shutter is ON and a second image of the background panel that is acquired when the mirror liquid crystal shutter is OFF.

### Item 12

The image capturing method for spatial observation according to item 11, further including:
disposing a filter on an optical path of reflected light reflected by the mirror and the mirror liquid crystal shutter;
allowing the filter to selectively transmit a first wavelength light and a second wavelength light having a different wavelength from the first wavelength; and
by the controller, switching the light source to switch between emitting the first wavelength light and emitting the second wavelength light.

### Item 13

The image capturing method for spatial observation according to item 11, further including:
disposing a filter on an optical path of reflected light reflected by the mirror and the mirror liquid crystal shutter;
allowing the filter to selectively transmit a first wavelength light and a second wavelength light having a different wavelength from the first wavelength; and
causing the controller to switch between a first light source emitting the first wavelength light and a second light source emitting the second wavelength light.

### Item 14

The image capturing method for spatial observation according to any one of items 11 through 13, further including:
allowing the mirror liquid crystal shutter to reflect the first wavelength light and to transmit the second wavelength light; and
causing the mirror to reflect the second wavelength light.

What is claimed is:

1. An image capture system for spatial observation, comprising:
a mirror disposed on one side surface of an observation target space;
a background panel including a pattern and being disposed so as to face the mirror in a predetermined orientation across the observation target space; and
an image capture device capturing an image of the background panel reflected in the mirror.

2. The image capture system for spatial observation according to claim 1, further comprising a light source configured to apply light to the background panel in an orientation such that reflected light reflected on the background panel passes through the observation target space and reflects on the mirror, and the reflected light reflected on the mirror passes through the observation target space and enters the image capture device.

3. The image capture system for spatial observation according to claim 1, wherein the background panel includes an image depicted by a backlighted liquid crystal device.

4. The image capture system for spatial observation according to claim 1, further comprising:
a mirror liquid crystal shutter disposed between the mirror and the image capture device and on a side surface opposite to the mirror across the observation target space; and
a controller, wherein
the controller is configured to execute:
a switching process of switching ON and OFF of the liquid crystal shutter; and
a process of acquiring an image of a gas flow flowing in the observation target space based on a first image of the background panel that is acquired when the mirror liquid crystal shutter is ON and a second image of the background panel that is acquired when the mirror liquid crystal shutter is OFF.

5. The image capture system for spatial observation according to claim 4, further comprising:
a filter disposed on an optical path of reflected light reflected by the mirror and the mirror liquid crystal shutter and selectively passing a first wavelength light and a second wavelength light having a different wavelength from the first wavelength, and wherein:
the light source is configured to switch between emitting the first wavelength light and emitting the second wavelength light; and
the controller is configured to further execute a process of switching the light emitted by the light source between the first wavelength light and the second wavelength light.

6. The image capture system for spatial observation according to claim 4, further comprising:
a filter disposed on an optical path of reflected light reflected by the mirror and the mirror liquid crystal shutter and selectively passing a first wavelength light and a second wavelength light having a different wavelength from the first wavelength, and wherein:
the light source includes a first light source emitting the first wavelength light and a second light source emitting the second wavelength light; and
the controller is configured to further execute a process of switching between light emission by the first light source and light emission by the second light source.

7. The image capture system for spatial observation according to claim 4, wherein:
the mirror liquid crystal shutter reflects the first wavelength light and transmits the second wavelength light; and
the mirror reflects the second wavelength light.

8. An image capturing method for spatial observation, comprising the steps of:
disposing a mirror on one side surface of an observation target space;
disposing a background panel so as to face the mirror in a predetermined orientation across the observation target space;
disposing an image capture device; and
capturing an image of the background panel reflected in the mirror using the image capture device.

9. The image capturing method for spatial observation according to claim 8, further comprising:
setting a light source so as to apply light to the background panel so that reflected light reflected on the background panel passes through the observation target space and reflects on the mirror, and the reflected light reflected on the mirror passes through the observation target space and enters the image capture device; and
causing the light source to apply light to the background panel.

10. The image capturing method for spatial observation according to claim 8, wherein the background panel includes an image depicted by a backlighted liquid crystal device.

11. The image capturing method for spatial observation according to claim 8, further comprising:
disposing a mirror liquid crystal shutter between the mirror and the image capture device and on a side surface opposite to the mirror across the observation target space; and wherein
the controller is configured to execute the processes of:
switching ON and OFF of the liquid crystal shutter; and
acquiring an image of a gas flow flowing in the observation target space based on a first image of the background panel that is acquired when the mirror liquid crystal shutter is ON and a second image of the background panel that is acquired when the mirror liquid crystal shutter is OFF.

12. The image capturing method for spatial observation according to claim 11, further comprising:
disposing a filter on an optical path of reflected light reflected by the mirror and the mirror liquid crystal shutter;
allowing the filter to selectively transmit a first wavelength light and a second wavelength light having a different wavelength from the first wavelength; and
causing the controller to switch the light source between emitting the first wavelength light and emitting the second wavelength light.

13. The image capturing method for spatial observation according to claim 11, further comprising:
disposing a filter on an optical path of reflected light reflected by the mirror and the mirror liquid crystal shutter;
allowing the filter to selectively transmit a first wavelength light and a second wavelength light having a different wavelength from the first wavelength; and
causing the controller to switch between a first light source emitting the first wavelength light and a second light source emitting the second wavelength light.

14. The image capturing method for spatial observation according to claim 11, further comprising:
allowing the mirror liquid crystal shutter to reflect the first wavelength light and to transmit the second wavelength light; and
causing the mirror to reflect the second wavelength light.
